(19) United States
(12) Patent Application Publication
(10) Pub. No.: US 2004/0101279 A1
(43) Pub. Date: May 27, 2004

(54) Image editing apparatus

(75) Inventors: Osamu Ikeda, Kenagawa (JP); Masahiro Juen, Kenagawa (JP); Masaharu Ito, Tokyo (JP)

Correspondence Address: MORGAN LEWIS & BOCKIUS LLP, 1111 PENNSYLVANIA AVENUE NW, WASHINGTON, DC, 20004, US

(73) Assignee: Nikon Corporation

(21) Appl. No.: 10/718,557

(22) Filed: Nov. 24, 2003

Related U.S. Application Data
(63) Continuation of application No. 09/004,339, filed on Jan. 8, 1998, now abandoned.
(60) Provisional application No. 60/053,426, filed on Jul. 22, 1997.

(30) Foreign Application Priority Data
Jan. 9, 1997 (JP) 09-001865
Apr. 1, 1997 (JP) 09-082570

(51) Int. Cl. H04N 5/781; G11B 27/00

(52) U.S. Cl. 386/52; 386/125

(57) ABSTRACT

An image editing apparatus includes a recording medium for recording an image file and a scenario file, wherein the scenario file is formed by recording a replay order or a replay condition of the image file with a predetermined file format, a scenario evaluating circuit for reading the scenario file from the recording medium and evaluating the replay order or the replay condition, an editor for editing the image file in response to an evaluation by the scenario evaluating circuit, and a recorder for recording the image file on the recording medium.

This application claims the benefit of Japanese Patent applications No. 09-001865, filed in Japan on Jan. 9, 1997, Japanese Patent application No. 09-82570, filed in Japan on Apr. 1, 1997, and U.S. provisional application No. 60/053,426, filed on Jul. 22, 1997, all of which are hereby incorporated by reference

### BACKGROUND OF THE INVENTION

1. Field of the Invention

The present invention relates to an image editing apparatus for editing an image file on a recording medium, and more particularly, to a portable image editing apparatus for editing image data, such as a portable camera.

2. Discussion of the Related Art

Recently, through developments in digital image processing using computer technology, image editing apparatuses that edit image files on a recording media have been implemented. One example of such an image editing apparatus is a device in which several image files are connected manually into a single image product.

In this kind of editing operation, an operator first categorizes a plurality of image files into several scenes corresponding to an intended production. Next, the image files are connected to each individualized scene by using the image editing apparatus. The final image product is completed by further connecting the intermediate levels of image files for each scene.

However, since the image files in intermediate levels are made by superimposition, the image editing apparatus must include a large capacity recording medium.

If the image editing apparatus is portable, such as an electronic camera with an integral image editor, it is difficult to provide a large-capacity recording medium, since portability and small size are desirable. As a result, attaching a complicated image editing function is too complex for an electronic camera with an integral image editing apparatus.

It is also possible to delete the original image file each time an intermediate-level image file is made in order to conserve space on the recording medium. However, with this approach, the revision of edited work becomes difficult, since the original image file is deleted. Additionally, a single image file cannot be flexibly used in editing operations, such as for reusing the image file for a plurality of scenes.

### SUMMARY OF THE INVENTION

Accordingly, the present invention is directed to an image editing apparatus that substantially obviates one or more of the problems due to the limitations and disadvantages of the related art.

One object to the present invention is to provide an image editing apparatus that can edit a plurality of image files flexibly, and at the same time effectively use the recording capacity of the recording medium.

Another object of the present invention is to simplify a file structure of an image editing apparatus.

Another object of the present invention is to provide an image editing apparatus that has a high recyclability of scenario files.

Another object of the present invention is to provide an image editing apparatus that can easily make the scenario file.

Another object of the present invention is to provide an image editing apparatus that can make a complex and high-level scenario file.

Another object of the present invention is to provide an image editing apparatus that can edit an image file even when the content of the scenario file has an inconsistency.

Another object of the present invention is to provide an image editing apparatus that can confirm the result of the image editing instantly even when in the middle of image editing.

Additional features and advantages of the present invention will be set forth in the description which follows, and will be apparent from the description, or may be learned by practice of the invention. The objectives and other advantages of the invention will be realized and attained by the structure and process particularly pointed out in the written description as well as in the appended claims.

To achieve these and other advantages and according to the purpose of the present invention, as embodied and broadly described, in accordance with a first aspect of the present invention there is provided an image editing apparatus including a recording medium for recording an image file and a scenario file, wherein the scenario file is formed by recording a replay order or a replay condition of the image file with a predetermined file format, a scenario evaluating circuit for reading the scenario file from the recording medium and evaluating the replay order or the replay condition, and an editor for editing the image file in response to an evaluation by the scenario evaluating circuit.

In another aspect of the present invention, there is provided an image recording and editing apparatus including a camera, a recording medium, a recorder, a display for displaying images received by the camera, a controller for controlling the display in response to a scenario file, wherein the images are recorded on the recording medium as image files by the recorder in response to commands from the controller and instructions stored in a scenario file.

In another aspect of the present invention there is provided an image recording and editing apparatus including a camera, an image memory for storing images received by the camera and connected to a common data bus, a recording medium, a disk drive positioned to record data on the recording medium and connected to the common data bus, a display for displaying images received by the camera, a display driver for driving the display and connected to the common data bus, a microprocessor connected to the common data bus for controlling the display in response to a scenario file, wherein the images are recorded on the recording medium as image files by the recorder in response to commands from the controller and instructions stored in a scenario file, and a compression/decompression circuit connected to the common data bus.

In another aspect of the present invention, there is provided a method of capturing and editing images, including the steps of capturing a first image, storing the first image on a recording medium, creating a control instruction, storing the control instruction as a scenario file, and displaying the first image, wherein the first image is modified according to the scenario file.

In another aspect of the present invention, there is provided an image reproducing apparatus including a memory for storing an image file including moving image data and a scenario file, wherein the scenario file includes a reproduction start point and a reproduction end point of the moving image data of the image file, and a reproducer for reproducing the moving image data in accordance with the reproduction start point and the reproduction end point.

In another aspect of the present invention, there is provided an image reproducing apparatus, including an image file including moving image data, a reproduction start point of the moving image data, and a reproduction end point of the moving image data, a memory for storing the image file; and a reproducer for reproducing the moving image data in accordance with the reproduction start point and the reproduction end point.

In another aspect of the present invention, there is provided an image reproducing apparatus, including a memory for storing moving image data, a reproduction start point of the moving image data, and a reproduction end point of the moving image data, and a reproducer for reproducing the moving image data in accordance with the reproduction start point and the reproduction end point.

It is to be understood that both the foregoing general description and the following detailed description are exemplary and explanatory and are intended to provide further explanation of the invention as claimed.

### BRIEF DESCRIPTION OF THE ATTACHED DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 is a basic operational block diagram of a preferred embodiment of the present invention;

FIG. 2 is another operational block diagram of the preferred embodiment of the present invention illustrating a replay operation;

FIG. 3 is another operational block diagram of the preferred embodiment of the present invention illustrating creation of a scenario file;

FIG. 4 is another operational block diagram of the preferred embodiment of the present invention illustrating resolution of a scenario file inconsistency;

FIG. 5 is another operational block diagram of the preferred embodiment of the present invention illustrating a replay mechanism;

FIG. 6 is a schematic block diagram of the preferred embodiment of the present invention;

FIG. 7 shows an isometric view of a physical structure of the preferred embodiment of the present invention;

FIG. 8 is a state diagram showing the operation of the preferred embodiment of the present invention;

FIG. 9 is a flow chart showing the operation of the edit screen B;

FIG. 10 is a flow chart showing the operation of the edit screen C;

FIG. 11 is a flow chart showing the operation of the edit screen D;

FIG. 12 is a flow chart showing the operation of the edit screen E;

FIG. 13 is a flow chart showing the operation of the replay mode;

FIG. 14 is a flow chart showing the operation of the video edit screen;

FIG. 15 shows the initial screen;

FIG. 16 shows the edit screen A;

FIG. 17 shows the edit screen B;

FIG. 18 shows the edit screen C;

FIG. 19 shows the edit screen D;

FIG. 20 shows the edit screen E;

FIG. 21 shows a display screen at the time of replay mode in conjunction with an image on the display;

FIG. 22 shows a video edit screen;

FIG. 23 shows a data structure of a scenario file; and

FIG. 24 shows the hierarchical structure for replay order.

### DETAILED DESCRIPTION OF THE PREFERRED EMBODIMENTS

Reference will now be made in detail to the preferred embodiments of the present invention, examples of which are illustrated in the accompanying drawings.

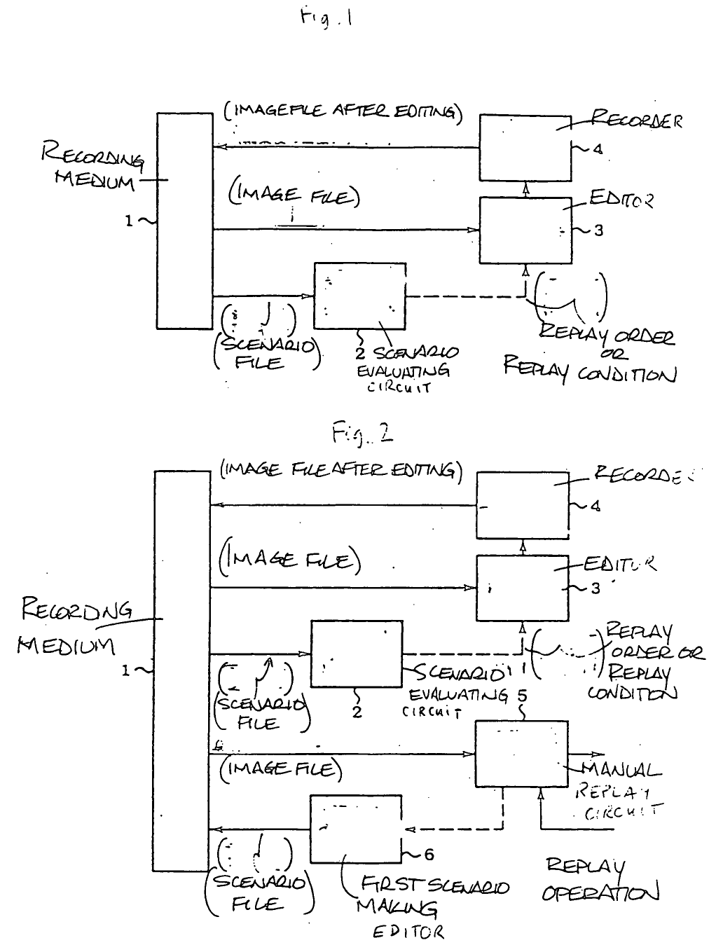

FIG. 1 is an operational block diagram of a preferred embodiment of the present invention. A recording medium 1 is used for recording a plurality of image files and a scenario file formed by recording a replay order of the image file or a replay condition with a pre-determined file format. A scenario evaluating circuit 2 receives the scenario file from the recording medium 1 and evaluates the replay order or the replay condition. An editor 3 edits an image file received from the recording medium according to the replay order or the replay condition. A recorder 4 records the image file edited by the editor to the recording medium.

The replay condition in the scenario file can be a replay speed of the image files, a number of replay repetitions of the image files, a replay range of the image files, a special effect added to the replay of the image files, or a replay condition of sound associated with the image file.

Identification data indicating other scenario files is recorded as data indicating a replay order. A scenario evaluating circuit 2 follows the corresponding scenario file in steps based on the identification data recorded in the scenario file, and evaluates the replay order of the image files.

FIG. 2 is another operational block diagram of the image editing apparatus including a manual replay circuit 5 that replays image files recorded on the recording medium 1 in response to an external replay operation command, and a first scenario making editor 6 that automatically records the replay order or the replay condition through the manual replay circuit.

FIG. 3 is another operational block diagram of the image editing apparatus showing an edit input unit 7 that receives an editing operation for a plurality of image files, and a second scenario making editor 8 that records a replay order or a replay condition as the scenario file based on the editing operation that was input to the edit input unit 7.

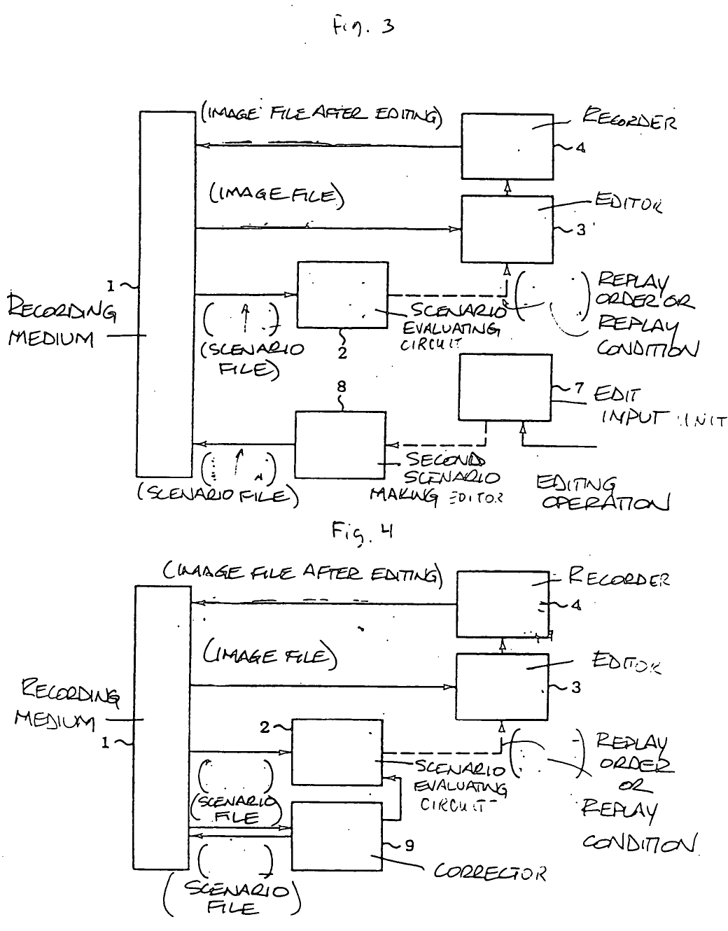

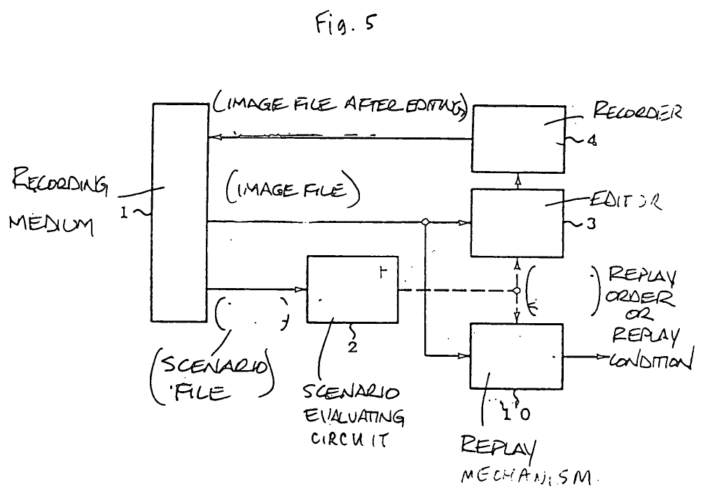

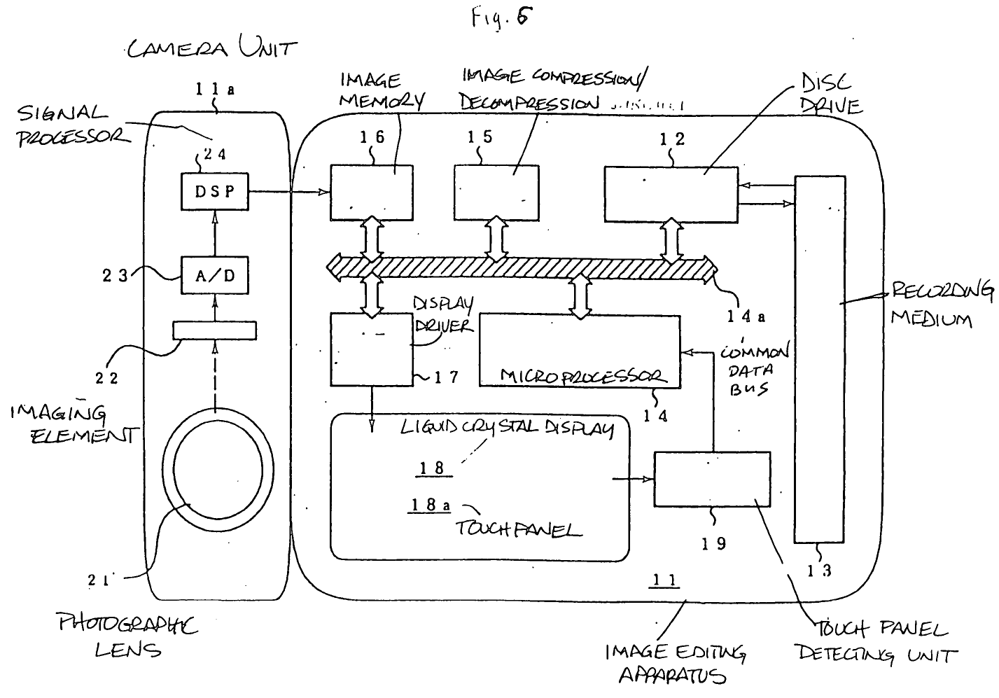

FIG. 4 is another operational block diagram showing a handling of inconsistencies between a plurality of replayed image files and a corresponding scenario file. The corrector 9 corrects the inconsistencies according to a pre-determined priority order or an external correction order.

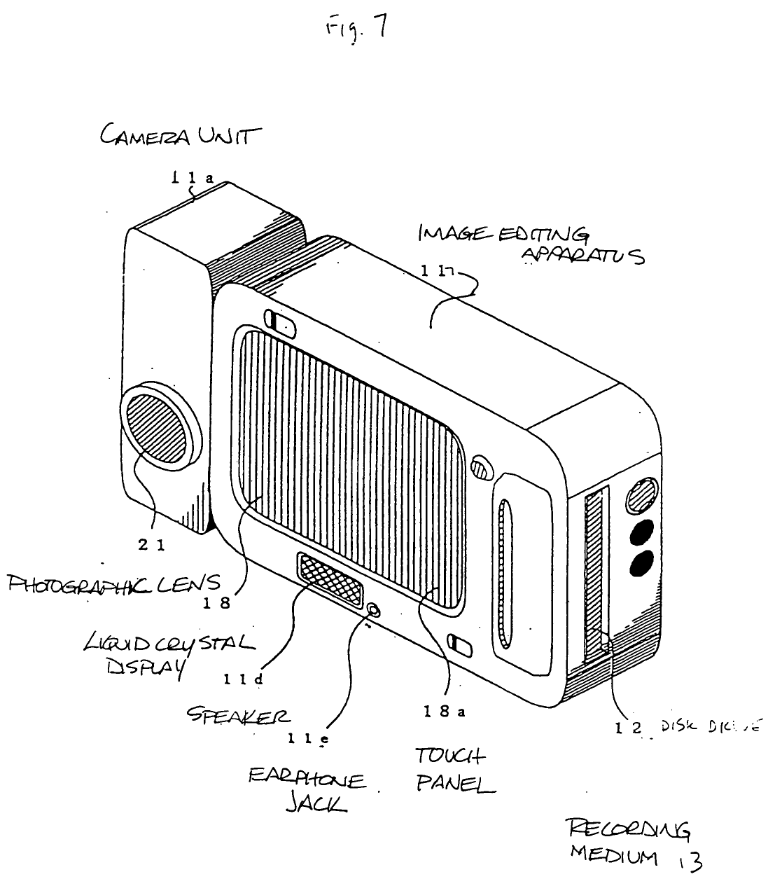

FIG. 5 is an operational block diagram illustrating that the replay mechanism 10 replays the image file input from the recording medium according to the replay order or replay condition evaluated by a scenario evaluating circuit 2.

In the image editing apparatus of the preferred embodiment, the scenario evaluating circuit 2 reads out the scenario file from the recording medium 1. The replay order or the replay condition has been previously recorded in the scenario file with a pre-determined file format.

The scenario evaluating circuit 2 evaluates the replay order or the replay condition based on this file format. The editor 3 edits the image file stored on the recording medium 1 according to the replay order or the replay condition determined by the scenario evaluating circuit 2. The recorder 4 records the edited image file on the recording medium 1.

The image editing apparatus 2 has recorded in the scenario file, as the replay condition, either a replay speed of the image files, a number of replay repetitions of the image files, a replay range of the image files, a special effect associated with the replay of the image files, or a replay condition of sound associated with the image files.

The scenario evaluating circuit 2 evaluates the replay order of the image files by following the scenario file in a hierarchical manner.

Since a complicated replay order is reproduced by following a plurality of scenario files in a hierarchical manner, the file structure for each scenario file is simplified. Moreover, since it is possible to integrate the already-edited scenario file into another scenario file, it is simple to reuse a particular scenario file.

The scenario file may be created automatically by recording a manual replay operation. Alternatively, the scenario file may be based on an editing operation. Any inconsistencies in the scenario file are corrected based on either a predetermined priority order or external correction instructions. The replay mechanism 10 replays the image files stored on the recording medium 1 by following the replay order or the replay condition evaluated by the scenario evaluating circuit 2.

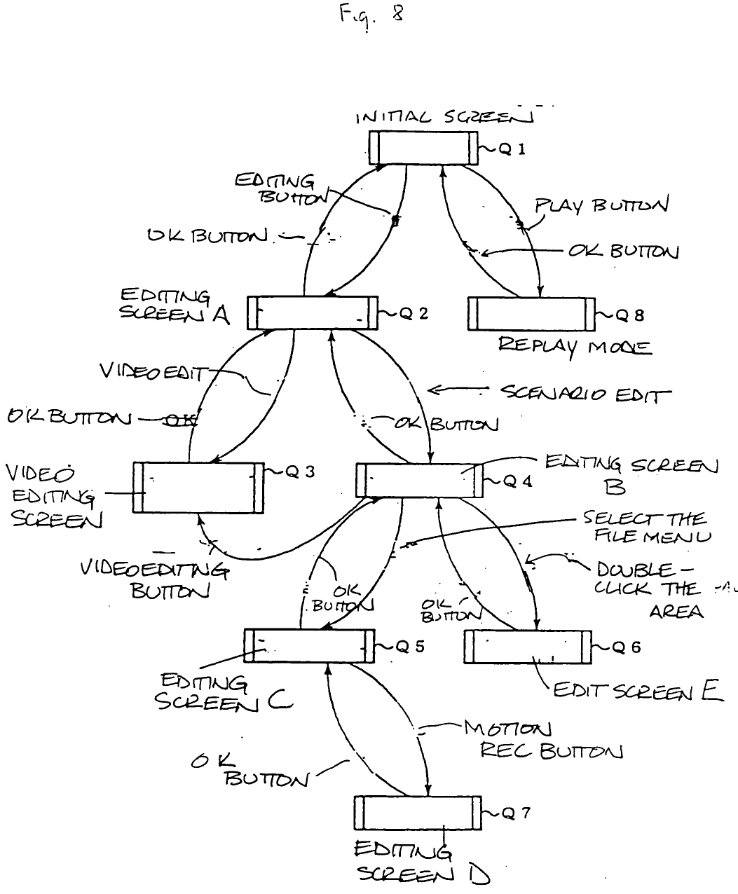

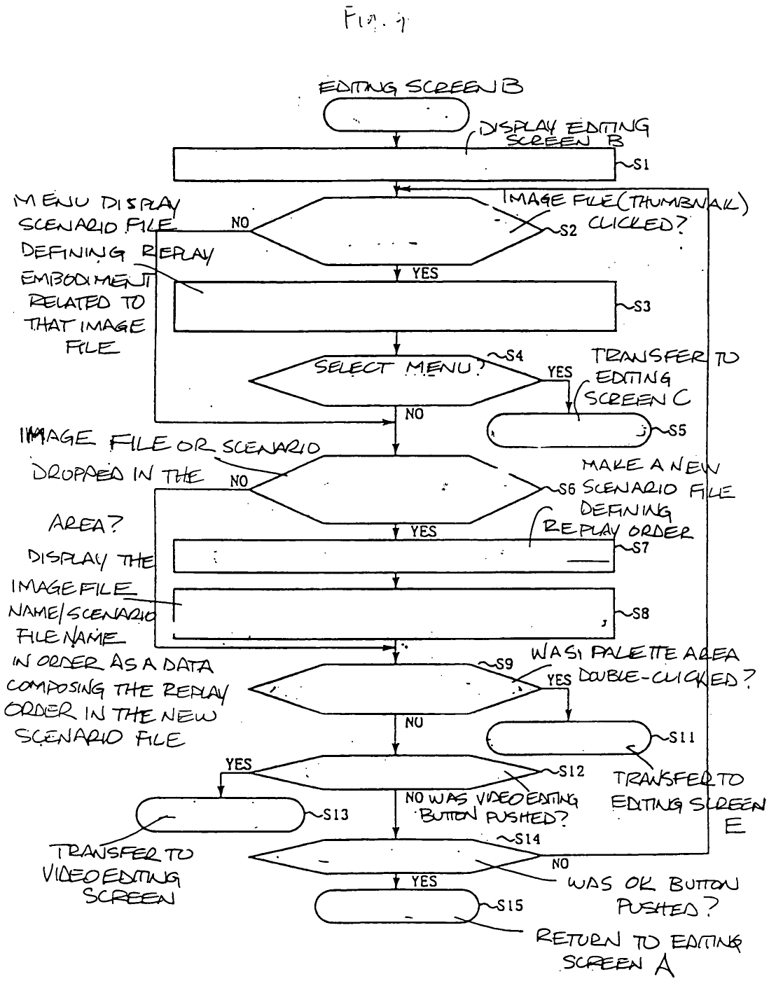

FIG. 6 is a schematic block diagram of a physical implementation of the preferred embodiment, and FIG. 7 is an isometric view of an external appearance of the physical implementation of the preferred embodiment. In FIGS. 6 and 7, a disk drive 12 is located within an image editing apparatus 11, and a recording medium 13 (such as, for example, a magneto-optical disk) is inserted into the disk drive 12 from the outside. The disk drive 12 is connected to a microprocessor 14 through a common data bus 14a. An image compression/decompression circuit 15, an image memory 16 and a display driver 17 are connected to the common data bus 14a.

The image output of the display driver 17 is connected to a liquid crystal display 18 positioned in front of the image editing apparatus 11. A touch panel 18a is affixed to the liquid crystal display 18, to sense the touch of a finger or a pen, and the output of the touch panel 18a is connected to a touch panel detecting circuit 19. The output of the touch panel detecting circuit 19 is outputted to the microprocessor 14.

A rotatable camera 11a is positioned on a side of the image editing apparatus 11. A photographic lens 21 is attached to a front face of the rotatable camera 11a. A light receiving component of an imaging element 22 is positioned at an image forming plane of the photographic lens 21. Photoelectric output of the imaging element 22 is connected via an A/D converter to a signal processor 24 that performs correction and color signal processing. Output of the signal processor 24 is input to an image memory 16 via a mechanical and electrical connection (not shown) between the camera 11a and the image editing apparatus 11.

A speaker 11d and an earphone jack 11e are positioned on the body of the image editing apparatus 11, and connected to an internal output amp (not shown) for sound effects.

The scenario evaluating circuit 2 performs the function of evaluating the data structure of the scenario file stored on the disk drive 12. The microprocessor 14 and the editor 3 perform the function of editing a plurality of image files based on the scenario file stored on the disk drive 12. The image compression/decompression circuit 15, the microprocessor 14, and the recorder 4 perform the function of recording connected edited image files stored on the disk drive 12 and the microprocessor 14. The manual replay circuit 5 performs the function of replaying image files corresponding to the manual replay operation of the touch panel 18a. The touch panel detecting circuit 19, the microprocessor 14, and the first scenario making editor 6 perform the function of making the scenario file data according to the replay operation of the microprocessor 14. The edit input unit 7 performs the function of evaluating the editing operation of the touch panel 18a, the touch panel detecting circuit 19 and the microprocessor 14. The second scenario making editor 8 performs the function of creating scenario file data according to the editing operation of the microprocessor 14.

The corrector 9 performs the function of resolving inconsistencies in the scenario file. Finally, the replay mechanism 10 performs the function of replaying a plurality of image files based on the scenario file via the display driver 17, the liquid crystal display 18 and the microprocessor 14.

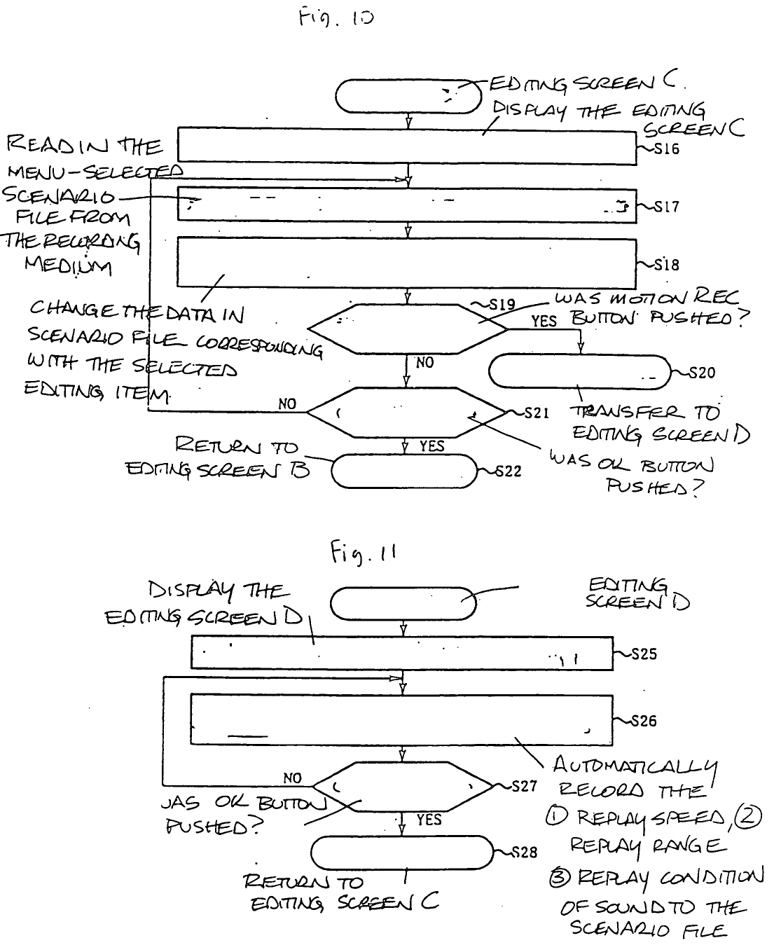

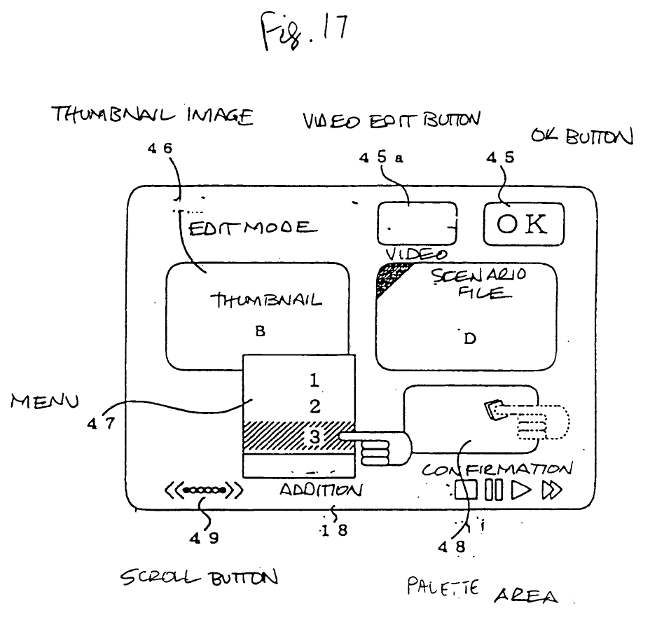

FIG. 8 is a state diagram illustrating the operation of the preferred embodiment. FIGS. 9-14 are flow charts explaining the operation of the preferred embodiment. FIGS. 15-22 show display screens produced by the preferred embodiment. The operation of the preferred embodiment will be explained in conjunction with a transition of the display screen of the liquid crystal display 18.

When the power is turned on, the microprocessor 14 displays an initial screen (shown in FIG. 15) on the liquid crystal display 18 via the display driver 17. In the initial screen, a sub-window 30 for receiving the replay operation is displayed, and thumbnail images 31 are displayed in an upper half of the sub-window 30.

The thumbnail images 31 are, for example, images that give a reduced display of the leading frames of the image files recorded on the recording medium 13. An image with a scenario file identification mark 32 is displayed along with the thumbnail images 31 that represents the scenario file. For example, the leading frame of the image file related to the scenario file is displayed in reduced form.

Below the thumbnail images 31, a scroll button 33 is shown for scrolling the thumbnail images 31 outside of the screen. Below the scroll button 33 a replay button 34 is shown for commanding the replay operation. Below the replay button 34, an editing button 35 is displayed. When the editing button 35 is clicked on (actuated) by a finger or the like, the touch panel 18a senses an actuation, such as, for example, pressure change. The touch panel detecting circuit 19 detects a position coordinate of a point of contact on the touch panel 11a and sends it to the microprocessor 14. The microprocessor 14 sends a message “the editing button has been actuated” to the display driver 17 based on the position coordinate of the point of contact. The display driver 17 then changes the display screen of the liquid crystal display 18 to the next screen, which is an editing screen A, following the message that “the editing button has been actuated.”

FIG. 16 shows the editing screen A, which is the same as the initial screen except that it has a scenario editing button 40, a video editing button 41, an OK button 42 in place of the replay button 34, and the editing button 35. When the OK button 42 is actuated, the display driver 17 returns the display screen to the initial screen. When the video editing button 41 is actuated on the screen A, the microprocessor 14 moves to a video mode which actually connects the image files on the recording medium 13.

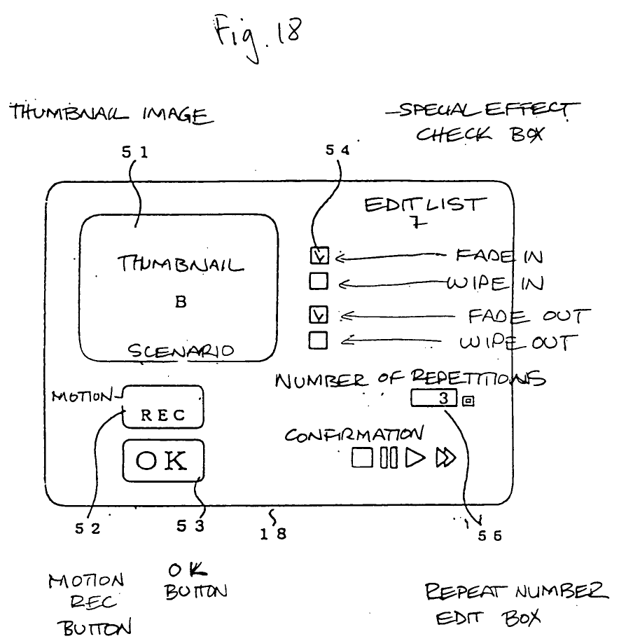

When the scenario editing button 40 is actuated on the screen A, the display driver 17 changes the display screen to an editing screen B, as shown in FIG. 17. In the editing screen B, an OK button 45 and a video editing button 45a are displayed at the upper right of the screen, and thumbnail images 46 are displayed in a horizontal line at the middle level of the screen. A palette area 48 is displayed at the lower right of the screen, and a scroll button 49 for scrolling the line display of the thumbnail images 46 is displayed at the lower left of the screen.

The operation of the image editing apparatus as controlled from the editing screen B is illustrated in the flow chart of FIG. 9. First, the display driver 17 displays the editing screen B on the liquid crystal display 18 (step S1). When a thumbnail image 46 is actuated (step S2), the microprocessor 14, first evaluates the image file which was thumbnail-selected. The microprocessor 14 then takes the list data of a scenario file Fse defining the replay embodiment related to the evaluated image file and displays it on a menu 47 (step S3). When an item on the menu 47 is actuated (step S4), the display driver 17 changes the display screen to an editing screen C (step S5).

On the other hand, in editing screen B, when an item on the menu 47 or a thumbnail image 46 is dragged and dropped into a palette area 48 (step S6), the microprocessor 14 records a new scenario file Fso defining the replay order on the recording medium 13 (step S7).

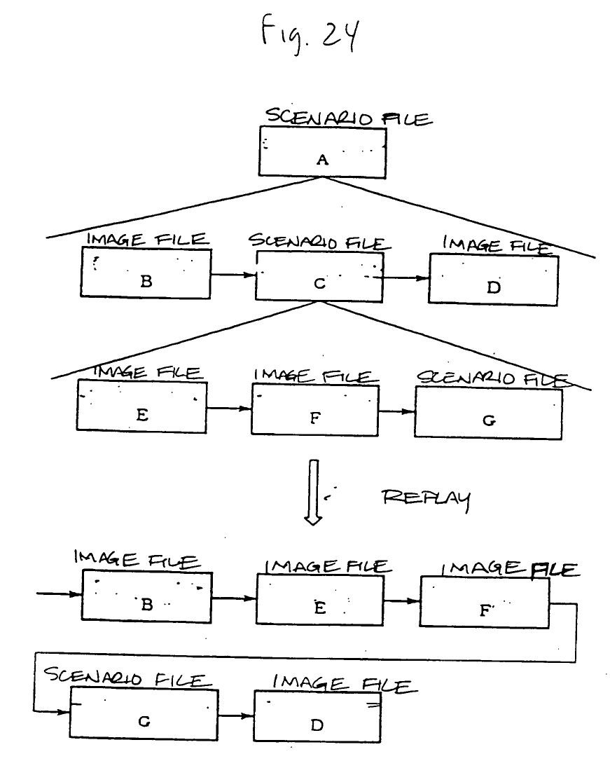

The data structure of the scenario file Fso is shown in FIG. 23. In the data structure, a next data item is stored in a position offset from a leading data item position, which is pointed to by a pointer pb:

| | |
|---|---|
| Position 1. | Scenario file name |
| Position 2. | Leading image file name or scenario file name |
| Position 3. | Second image file name or scenario file name |
| | . |
| | . |
| | . |
| Position N + 1. | Nth image file name or scenario file name |
| Position N + 2. | Finish code |

Every time the thumbnail image 46 or the menu 47 is dropped, the microprocessor 14 adds the name of the image file or the name of the scenario file to the scenario file data (step S8). Moreover, in the editing screen B, when the palette area 48 is double clicked (i.e. actuated twice in rapid succession) (step S9), the display driver 17 changes the display screen to an editing screen E (step S11). Further, in the editing screen B, when the video editing button 45a is actuated (step S12), the display driver 17 changes the display screen to the video editing screen (step S13). The microprocessor 14 repeatedly executes these operations until the OK button 45 is actuated.

When the OK button is actuated (step S14), the display driver 17 returns the display screen to the editing screen A (step S15).

As described above, the editing screen B is used mainly for creating a new scenario file Fso.

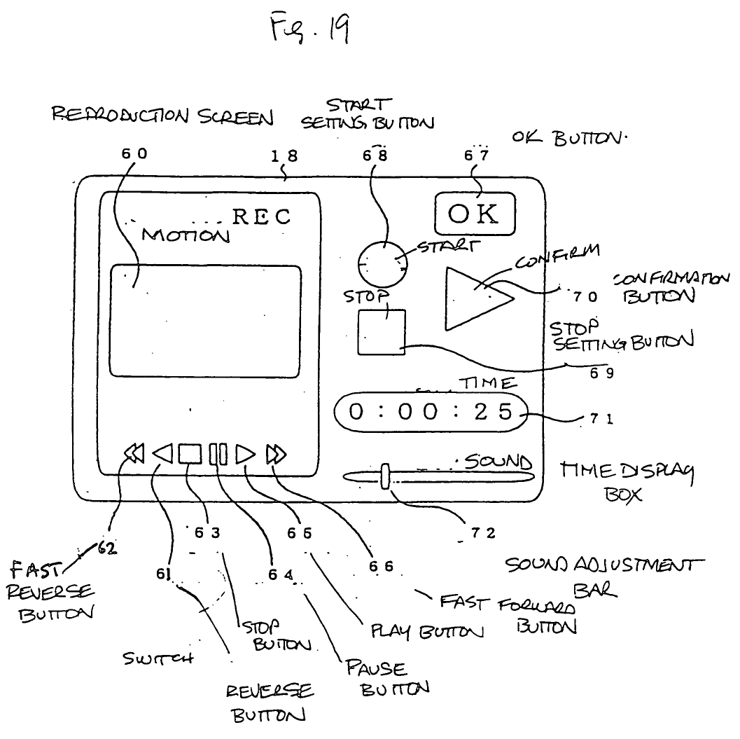

FIG. 18 shows the editing screen C, in which a thumbnail image 51 of the scenario file menu-selected in the editing screen B, is displayed at the upper left of the editing screen C. Below the thumbnail image 51, a motion REC button 52 and an OK button 53 are displayed.

On the right upper side of the screen, special effect check boxes 54 are displayed in a vertical line. Below the special effect check boxes 54, an edit box 55 for the number of repetitions is displayed.

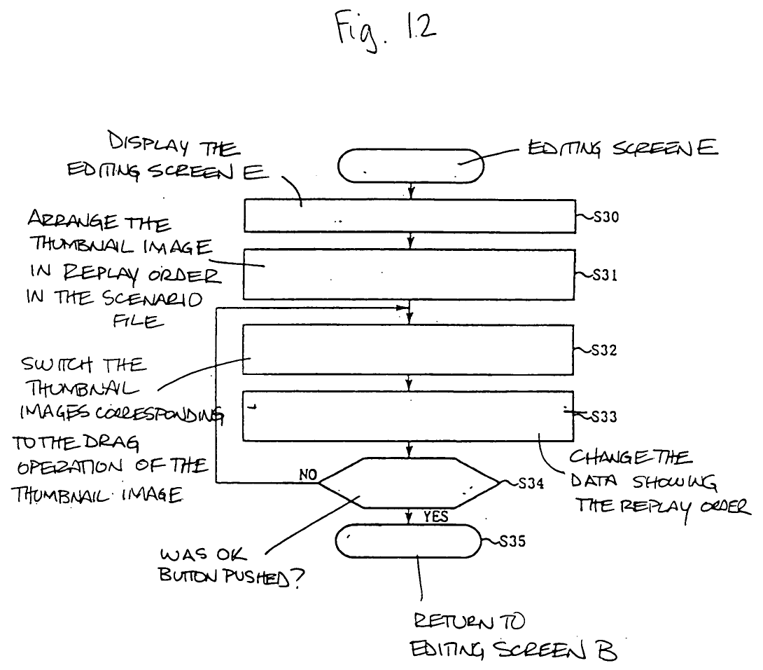

The operation of the image editing apparatus as controlled from the edit screen C is illustrated in FIG. 10. First, the display driver 17 displays the edit screen C on the display screen (step S16). The microprocessor 14 reads out from the recording medium 13 a scenario file Fsc defining the replay condition that was selected from the menu in the editing screen B (step S17). In the editing screen B of FIG. 17, when the “addition” column is selected from the menu, the microprocessor 14 creates the scenario file defining Fsc. A data structure of the scenario file Fsc is shown in FIG. 23. In the data structure, a next data item is stored offset from a lead data item, which is pointed to by a pointer pa:

| | |
|---|---|
| Position 1. | Scenario file name |
| Position 2. | Name of image file to be associated |
| Position 3. | Replay starting point |
| Position 4. | Replay finish point |
| Position 5. | Replay speed (pause, reverse play and fast forward and the |
| | like are stored with time sequencing information) |
| Position 6. | Number of replay repetitions |
| Position 7. | Special effect (fade in, wipe in and the like) |
| Position 8. | Sound replay condition (sound and the like is stored with |
| | time sequencing information). |

The microprocessor 14 renews the corresponding data in the scenario file each time the special effect check box 54 and the repetition number edit box 55 are changed (step S18). On the other hand, in the editing screen C shown in FIG. 18, when the motion REC button 52 is actuated (step 19), the display driver 17 displays the editing screen D in the display screen (step S20). The microprocessor 14 repeatedly performs these steps until the OK button 53 is pressed.

On the other hand, in the editing screen C, when the OK button 53 is actuated (step S21), the display driver 17 returns the display screen to the editing screen B (step S22).

As described above, in the editing screen C, the data renewal of “scenario file defining the replay condition” is mainly executed on the editing screen C.

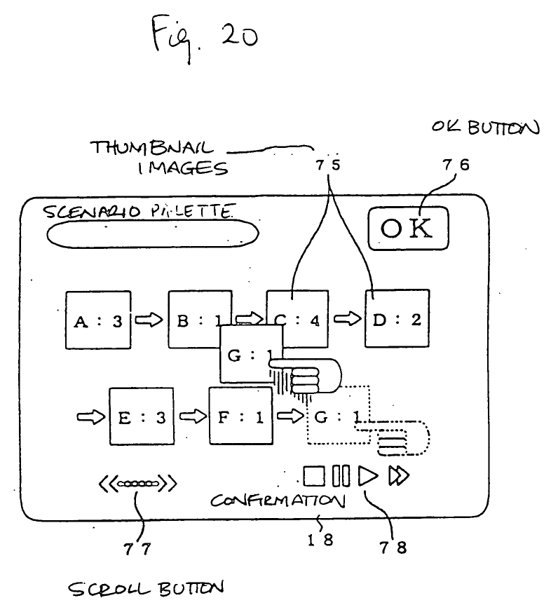

FIG. 19 shows the editing screen D, illustrating a replay screen 60, which is displayed on the left side of the screen. Below the replay screen 60, in order from left to right, a fast reverse button 62, a reverse button 61, a stop button 63, a pause button 64, a replay button 65 and a fast forward button 66 are displayed. An OK button 67 is located at the upper right of the screen. A start setting button 68, a stop setting button 69, and a confirmation button 70 are displayed at the middle of the right side of the screen. At the lower right of the screen, a time display box 71 displays the replay time, and a sound adjustment bar 72 adjusts the replay sound.

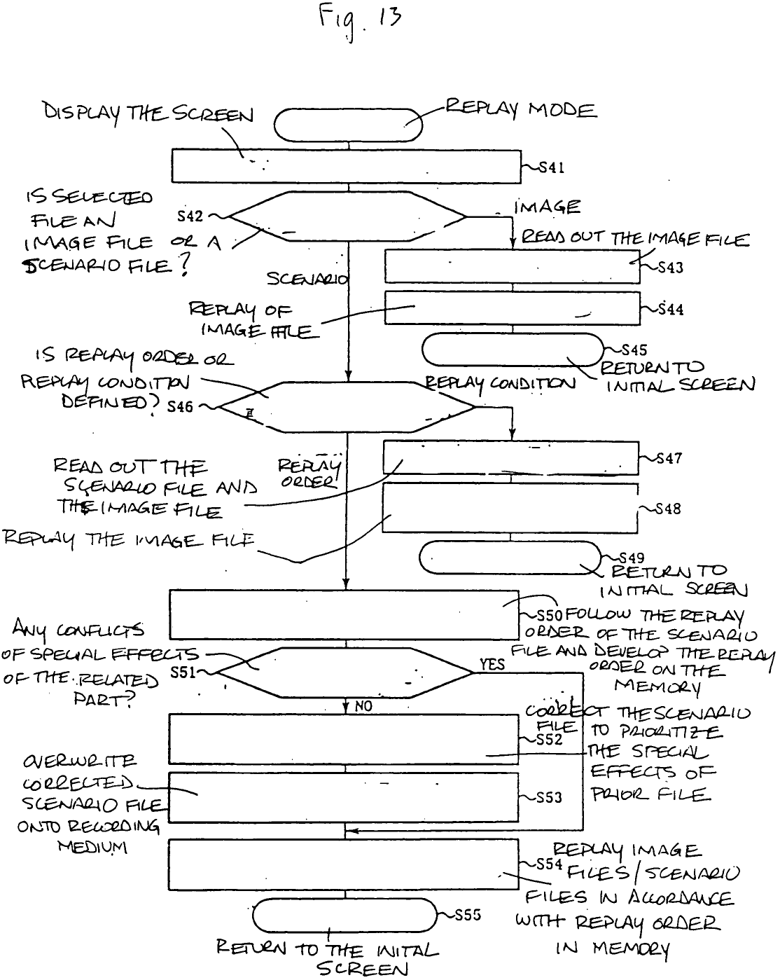

The operation of the image editing apparatus as controlled from the editing screen D is illustrated in a flow chart shown in FIG. 11. First, the display driver 17 displays the editing screen D on the display screen (step S25). In the editing screen D, the microprocessor 14 takes in the manual replay operation of the replay button 65 or the like. The microprocessor 14 reads out the image files of originals related to the scenario file menu-selected in the editing screen B from the recording medium 13. Images in the image files that have been read out are decompressed and stored in the image memory 16 in order of their readout by the image compression/decompression circuit 15. The display driver 17 replays the images from the image memory 16 according to a command of the replay condition given by the microprocessor 14.

For example, when the fast forward button 66 is pressed, the display driver 17 reads out an image every several frames from the image memory 16 and displays those images on the replay screen 60 in order. When the pause button 64 is pressed, the display driver 17 repeatedly reads out an image for one frame from the image memory 16, and displays the image on the replay screen 60.

During the replay period, when the start setting button 68 is actuated, the microprocessor 14 stores a frame number of the image displayed on the replay screen 60 at a current point in the data area of the replay start point in the scenario file. From this point, the microprocessor 14 stores the change of the replay speed in the replay speed data area of the replay scenario file.

When the sound adjustment bar 72 is operated, the microprocessor 14 stores the change of the replay sound amount in the sound replay condition data area of the scenario file. When the stop setting button 69 is actuated, the microprocessor 14 stores the frame number of an image displayed on the replay screen 60 at the current point in the replay stop point data area of the scenario file (step S26). The microprocessor 14 repeatedly performs this series of operations until the OK button 67 is actuated. When the OK button 67 is actuated (step S27), the display driver 17 returns the display screen to the editing screen C (step S28). Thus, in the editing screen C, the manual replay operation is automatically recorded in the scenario file.

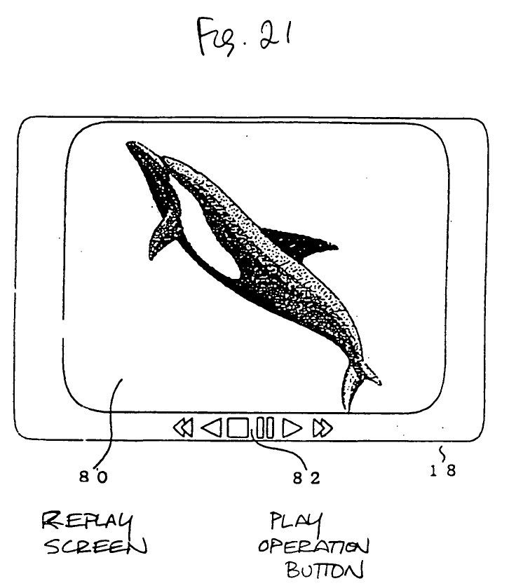

FIG. 20 shows the editing screen E. In the editing screen E, an OK button 76 is displayed at the upper right of the screen, and thumbnail images 75 are displayed on several lines in the middle of the screen. In the lower left portion of the screen, a scroll button 77 that scrolls the line display of the thumbnail images 75 and a replay operation button 78 for confirmation are displayed.

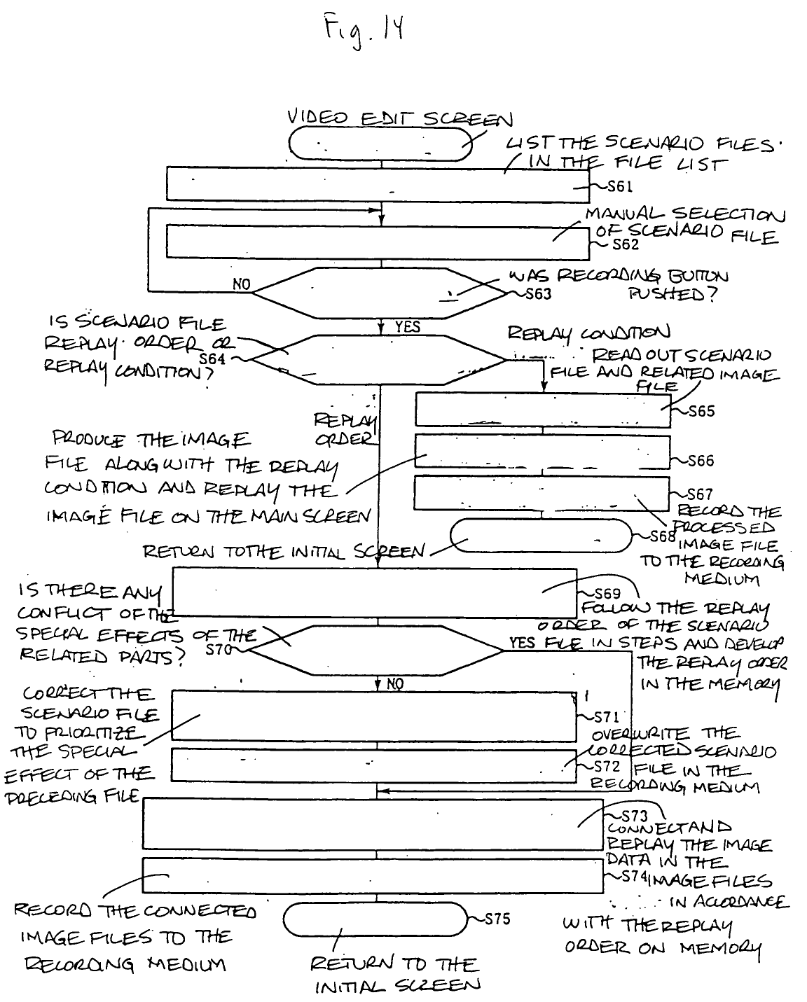

The operation of the preferred embodiment as controlled from the editing screen E will be explained with reference to a flow chart shown in FIG. 12. First, the display driver 17 displays the editing screen E on the display screen (step S30). Next, the microprocessor 14 receives the scenario file that was created using the palette area 48 of the editing screen B. The display driver 17 line-displays the thumbnail images 75 according to the replay order defined by the scenario file (step S31). When one thumbnail image 75 is dragged, the display driver 17 changes the position of the thumbnail image 75 by following the movement of the drag operation.

Moreover, when the thumbnail image 75 is dropped between the two thumbnail images, the thumbnail image 75 is inserted between the two thumbnail images, and positions of all the thumbnail images 75 may be shifted (step S32). The microprocessor 14 changes the data item indicating the replay order in the scenario file to correspond to the new order of the thumbnail image 75 (step S33). The microprocessor 14 repeatedly executes this series of operations until the OK button 76 is pressed.

When the OK button 76 is actuated (step S34), the display driver 17 returns the display screen to the editing screen B (step S35). In the editing screen E, the data showing the replay order in the scenario file can be changed easily as described above.

Moreover, during the editing operation, when the replay operation button 78 for confirmation shown in FIG. 20 is selected, the microprocessor 14 creates a sub-window for the replay screen, and the image files are replayed in order according to the current replay order in that sub-window.

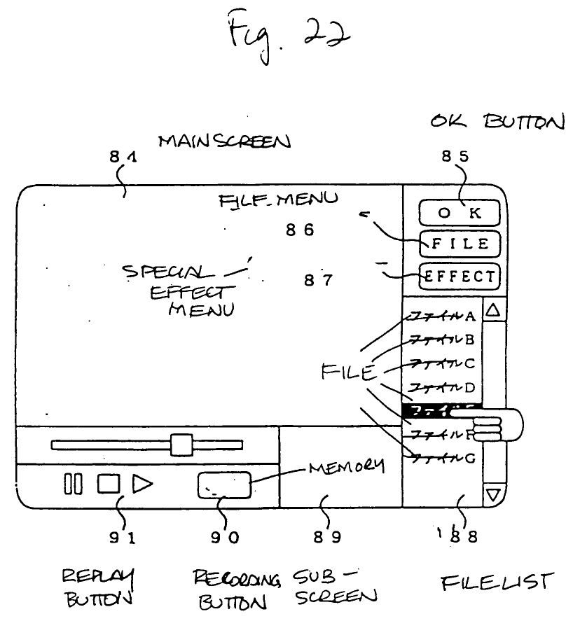

FIG. 21 shows the display screen during replay. On the display screen, a large replay screen 80 is displayed and a replay operation button 82 is displayed below the replay screen 80.

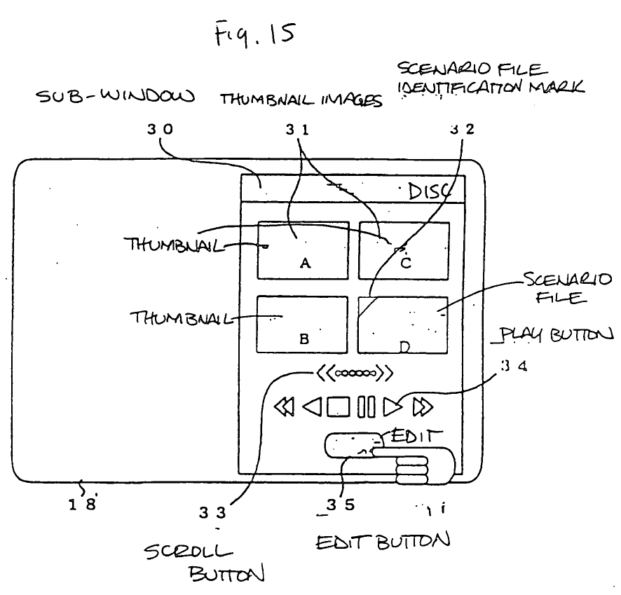

The replay operation of the embodiment will be explained with reference to the flow chart shown in FIG. 13.

First, the display driver 17 displays the screen frame of the replay screen 80 (step S41). Next, the microprocessor 14 determines whether the file that was thumbnail-selected in the initial screen was an image file or scenario file (step S42).

When the image file is thumbnail-selected, the microprocessor 14 reads out the image files from the recording medium 13 via the disk drive 12 (step S43). The image compression/decompression circuit 15 decompresses the data of the image files, and successively stores the data in the image memory. The display driver 17 successively displays the image information from the image memory 16 on the replay screen 80 (step S44). The display driver 17, after replaying the image files, returns the display screen to the initial screen (step S45).

On the other hand, in step S42, if a scenario file is thumbnail-selected, the microprocessor 14 evaluates whether the replay order or the replay condition is requested, based on the data structure of the scenario file (step S46).

When the scenario file requests a replay condition, the microprocessor 14 reads out the scenario file and the image files of the related originals from the recording medium 13 via the disk drive 12 (step S47). Next, the microprocessor 14 gets the replay start point data item and the replay finish point data item from the data structure of the scenario file, and transfers the replay start point and the finish point data item to the image compression/decompression circuit 15. The image compression/decompression circuit 15 decompresses the image file data before and after the replay start frame, and successively stores the image file data in the image memory 16. The display driver 17 transfers the frame number of the image in the image memory 16 to the microprocessor 14. The microprocessor 14 transmits the replay speed in the scenario file, the replay condition of sound, and special effects to the display driver 17 according to the frame number. The display driver 17 changes the frame display time period, the replay condition of sound data included in the image file and the special effects in response to a command from the microprocessor 14 (step S48). The image compression/decompression circuit 15 completes the decompression of the image file and decompresses the frame of the replay stop point. The display driver 17 returns the display screen to the initial screen after completing the replay of the image in the image memory 16 (step S49).

On the other hand, in step S46, if it is determined that the scenario file defines the replay order, the microprocessor 14 reads out the scenario file from the recording medium 13 via the disk drive 12. The microprocessor 14 follows the replay order step by step, and processes the data of the replay order in a memory inside the microprocessor 14 (step S50).

In short, as shown in FIG. 24, the data corresponding to (image file B+scenario file C+image file D) is recorded in the scenario file A. The microprocessor 14 reads out the scenario file C that defines the replay order. In the scenario file C, the data corresponding to (image file E+image file F+scenario file G) is recorded. Since the scenario file G defines the replay condition, the replay order is not followed any further. As a result, the replay order stored on the memory becomes: (image file B+image file E+image file F+scenario file G+image file D).

The microprocessor 14 finds the connected parts of the scenario file that defines the replay condition, and evaluates whether an inconsistency has arisen in the special effects or the like of the connected parts, based on, for example, a predetermined comparison chart (step S51).

For example, when a fadeout and a wipe-in are both requested, an inconsistency occurs. When this happens, the microprocessor 14 deletes the appropriate data item of the later scenario file in order to prioritize the special effect of the preceding scenario file (step S52). The microprocessor 14 over-writes the corrected scenario file onto the recording medium 13 (step S53). With the inconsistency resolved, the microprocessor 14, the image compression/decompression circuit 15 and the display driver 17 replay the image files or the scenario file in order according to the replay order stored in the memory (step S54). The display driver 17 returns the display screen to the initial screen after completing the replay of the images in the image memory 16 (step S55).

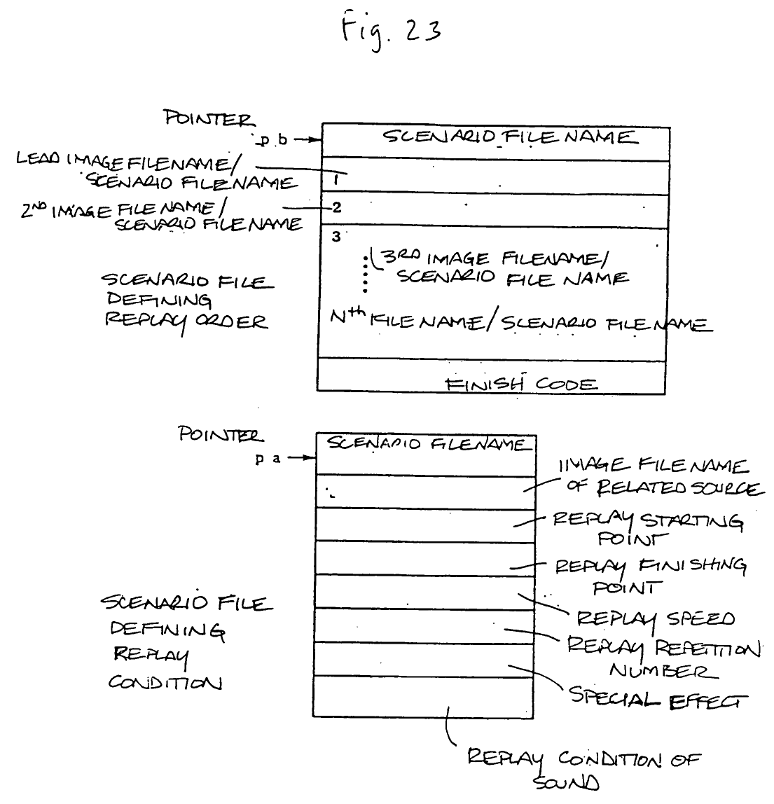

FIG. 22 shows the video editing screen. On the video editing screen, a large main screen 84 is displayed, and an OK button 85, a file menu 86 and a special effect menu 87 are all displayed on a right side of the main screen 84. A selection menu of trimming adjustment, addition of a specified screen frame and a color tone adjustment, for example, is displayed by selecting an option from the special effect menu 87. Below the special effect menu 87, a file list 88 is displayed that lists the scenario files. At the lower right of the main screen 84, a sub-screen 89 is displayed for confirming a screen effect from the special effect menu 87. At a lower left of the main screen, a recording button 90 and a replay button 91 are displayed. The replay button 91 has the same function as the replay operation button 82 in the replay screen described above with reference to FIG. 21.

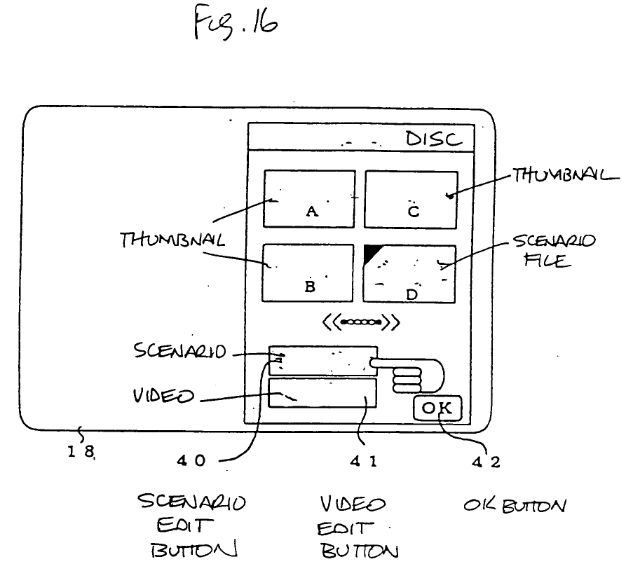

The operation of the preferred embodiment of the image editing apparatus in connection with the recording button 90 will be explained based on a flow chart shown in FIG. 14. First, the microprocessor 14 gets the file names of the scenario files via the disk drive 12, and lists the file names in a file list 88 (step S61). Next, the microprocessor 14 obtains the manual selection of the file list 88 via the touch panel 18a (step S62). This operation is repeated until the recording button 90 is pressed. However, during this period, if the replay button 91 on the special effect menu 87 or the like is operated, the microprocessor 14 carries out the commanded operation.

If the recording button 90 is pressed (step S63), the microprocessor 14 evaluates whether the selected scenario file defines a replay order or a replay condition, based on the data structure of the scenario file (step S64). If the scenario file defines a replay condition, the microprocessor 14 reads the scenario files and the image files of related originals from the recording medium 13 (step S65).

Next, the microprocessor 14 takes in the replay start point data item and the replay finish point data item from the data structure of the scenario file, and transfers them to the image compression/decompression circuit 15. The compression/decompression circuit 15 stores the image file data in the image memory 16 by decompressing data from frames before and after the frame of the replay starting point. The display driver 17 transfers the frame number of the image in the image memory 16 to the microprocessor 14. The microprocessor 14 transfers corresponding data such as the replay speed in the scenario file, the replay condition of sound and a special effect to the display driver 17 according to the frame number. The display driver 17 changes the time period of the frame display, replay condition of sound data included in the image file, and the special effect and the like in synchronization with the corresponding data.

The image data that has been processed based on the scenario file is replayed and displayed on the main screen 84, and saved successively in the image memory 16 (step S66). In the image memory 16, each time the processed image data is saved for a predetermined period, the image compression/decompression circuit 15 temporarily suspends the decompression operation, and compresses the image data.

The disk drive 12 records a new image file on the recording medium 13, and stores the images one by one after compressing the image file (step S67). The image compression/decompression circuit 15 completes the decompression of the image file when the decompression operation of the replay stop point is reached. The display driver 17 waits for the storing of the image data to be completed, and then returns the display screen to the initial screen (step S68).

On the other hand, in step S64, when the scenario file defines a replay order, the microprocessor 14 reads out the scenario file from the recording medium 13 via the disk drive 12. The microprocessor 14 follows the replay order in steps as shown in FIG. 24, and processes the replay order data in the memory inside of the microprocessor 14 (step S69). The microprocessor 14 searches for associated parts of scenario files that define a replay condition, and evaluates whether an inconsistency has occurred in the special effects or the like based on a predetermined comparison chart (step S70).

If an inconsistency occurs, the microprocessor 14 deletes the appropriate data item of a later scenario file in order to prioritize the special effect of a preceding scenario file (step S71). The microprocessor 14 then stores the corrected scenario file to the recording medium 13 (step S72). With the inconsistency resolved, the microprocessor 14 reads out the image files according to the replay order via the disk drive 12.

The image data in the image files that have been read out in order based on the scenario file is connected successively in the image memory 16, and is replayed and displayed on the main screen 84 (step S73). The image data thus connected are output to the disk drive 12 one by one after being image compressed one by one by the image compression/decompression circuit 15.

The disk drive 12 stores new image files on the recording medium 13, and stores the connected image data in the image files one by one (step S74). After storage of the connected image data is complete, the display driver 17 returns the display screen to the initial screen (step S75).

As explained above, in the preferred embodiment of the present invention, since the replay order is reconstructed from the following scenario file in a hierarchical manner, the file structure can be simplified. Moreover, a scenario file that has already been edited can be assembled in its existing form into a scenario file. Accordingly, it is not necessary to make an intermediate step of creating the image file during the editing operation. As a result, storage capacity of the recording medium can be used effectively and without waste.

Moreover, since the scenario file is created by automatically recording the manual replay operation, creation of the scenario file is easy. Also, since the scenario file can be created based on high-level editing operations, complex editing operations which cannot be designated by a manual replay operation can be included in the scenario file. Further, since inconsistencies in the scenario file are corrected automatically, based on a predetermined priority order, the image files corresponding to a particular scenario file can be edited at any time.

Moreover, since the scenario files defining the replay condition and the replay order are separated, the data structure of the scenario file is simple and allows for a reduction in the amount of information processing. Furthermore, since the replay of image files can be performed by reading out the scenario file, the editing operation can be performed with a rapid confirmation of the editing result.

Moreover, a camera component 11a captures the image to be stored in the image file. It is therefore possible to create the scenario file for the image file corresponding to the captured image immediately after photographing. Accordingly, the inconvenience of having to perform the editing operation while remembering the photograph contents after time has passed can be eliminated.

In the preferred embodiment, the scenario files defining the replay condition and the replay order are separated. However, it is possible to include both in one scenario file. Moreover, the image files and the scenario file are separated in the preferred embodiment, but it is possible to record the scenario file as part of the image files.

Furthermore, although a magneto-optical recording medium is used as the recording medium in the preferred embodiment, any recording medium, such as magnetic, semiconductor, or optical media may be used.

Further, although in the preferred embodiment the image files and the scenario files are recorded on the same recording medium, the scenario files and the image files can be separately recorded on different recording media.

Moreover, although the above embodiment describes recording the edited image files on the recording medium on which the original image files recorded, the edited image files can be recorded on a different recording medium.

Further, when the scenario file has an inconsistency, the preceding image replay is automatically prioritized; however, it is possible to automatically prioritize succeeding image replay, or to predetermine the priority for various types of inconsistencies. It is also possible to receive a prioritization order from the outside via the touch panel 18a at the time of an occurrence of the inconsistency.

Further, the inconsistency in the scenario file is automatically corrected at the time of replay or video editing, however, it is possible to automatically correct the inconsistency of the scenario file during the editing operation shown in FIG. 24, or to simply warn the user when the inconsistency occurs. Thus, it is possible to find the inconsistency quickly, and to correct the inconsistency quickly and easily during the editing of the scenario file.

Some examples of the replay conditions (including the special effects) are described, however, the replay conditions may be anything that indicates a condition shown on the screen or sound at the time of replay condition.

Moreover, it is possible that the image files will be photographed at a future time by the camera 11a or the like (i.e. the image file may not yet exist at that point in time), and to add a file controller that treats this type of image files as if they already existed. By adding such a file controller, it is possible to combine the image files that will be photographed later to replay order data and the like in the scenario file in advance.

Accordingly, it is possible to make the scenario file in advance, following a photography plan such as a picture conté (i.e. a picture sketch sequence that roughly relates to plot or sequence of, for example, a movie, or a story, or a segment thereof). By preparing the scenario file in advance, not only can a series of photographs be completed, but an almost-edited film work can be completed as well.

As explained above, automatic editing of the image files is performed according to the replay order or the replay condition of scenario files. Usually this kind of a scenario file is constructed centered mainly around the replay order data or the replay condition data. This can be done when the information amount is small compared to the image file that includes the image information itself. Accordingly, the recording capacity of the recording medium can be used effectively.

An editing operation by the user can be done even if performed on newly created scenario files or on new data. As a result, there is less need to preserve the image files one by one in intermediate steps during the editing. Accordingly, in addition to increasing the speed of the editing operation, the recording capacity of the recording medium is used effectively and without waste.

Since the preferred embodiment of the present invention evaluates the replay order by following the scenario file in a hierarchical order, the file structure can be simplified for each scenario file. Moreover, the reusability of the scenario file is extremely high since the edited scenario file is assembled in a hierarchical manner in the scenario file.

Further, the scenario file of a final film work can be structured such that scenario files are divided and edited for every scene in a hierarchical manner. Accordingly, in editing operations by the editor, a scenario file is made for every scene, and the scenario files may be joined into an appropriate sequence. Therefore, there is less need to make the image files one by one and preserve them for each scene, and it is possible to use the recording capacity of the recording medium effectively and without waste. Therefore, the image editing apparatus of the present invention is suitable for performing an image edit for each scene.

The present invention also makes the scenario file by automatically recording the manual replay operation, and thus can easily create scenario files. Since the present invention makes the scenario files based on the editing operation, creation of high quality scenario files is possible by designating complex editing operations.

The present invention automatically corrects an inconsistency in the scenario file according to predetermined prioritization order or a correction instruction. Therefore, even if the scenario file has an inconsistency, the image editing can still be performed.

In this preferred embodiment, the reproduction start time point and the reproduction end time point are recorded in the corresponding data areas in terms of the frame number of the image. However, it is not always necessary to record the frame number in the data areas. For example, time stamp data, which are included in the MPEG type image file in addition to image data, may be written on the data areas instead.

The present invention can also approximately confirm the image file after edit completion at the scenario file level.

Also, the reproduction start point and the reproduction end point may be stored in the image file itself instead of being stored in the scenario file.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. An image editing apparatus, comprising:
a recording medium for storing an image file and a scenario file, wherein the scenario file is formed by recording a replay order or a replay condition of the image file with a predetermined file format;
a scenario evaluating circuit for reading the scenario file from the recording medium and evaluating the replay order or the replay condition; and
an editor for editing the image file in response to an evaluation by the scenario evaluating circuit.

2. The image editing apparatus of claim 1, further including a recorder for recording the image file on the recording medium.

3. The image editing apparatus of claim 1, wherein the scenario file comprises at least one of a replaying speed of the image file, a number of repetitions for replaying the image file, a replay range of the image file, a special effect, and a replay of sound associated with the image file.

4. The image editing apparatus of claim 1, wherein the scenario file includes identification data indicating if other scenario files are recorded as part of the scenario file; and
wherein the scenario evaluating circuit evaluates the replay order of the image files by following the corresponding scenario file in a hierarchical manner based on the identification data.

5. The image editing apparatus of claim 1, further including:
a manual replay circuit for replaying the image files recorded in the recording medium according to an external replay operation; and
a first scenario editor that records a sequence of manual steps as a replay order or replay condition in the scenario file.

6. The image editing apparatus of claim 1, further including:
an edit input unit for receiving the editing operation for the plurality of image files, and a second scenario making editor for recording a replay order or a replay condition as a scenario file based on the editing operation received from the editing input unit.

7. The image editing apparatus of claim 1, further including a corrector for detecting an inconsistency when the plurality of image files is replayed along with the scenario file, and for correcting the inconsistency according to one of a predetermined priority order or an externally input correction instruction.

8. The image editing apparatus of claim 1, wherein a replay mechanism replays image files take in from the recording medium according to the replay order or the replay condition evaluated by the scenario evaluating circuit.

9. The image editing apparatus of claim 1, wherein the recording medium further includes a first recording medium for storing the image file and a second recording medium for storing the scenario file.

10. An image recording and editing apparatus, comprising:
a camera;
a recording medium;
a recorder;
an image file representing an image acquired by the camera and stored on the recording medium by the recorder;
a scenario file stored on the recording medium;
a display; and
a controller for controlling the display according to instructions stored in the scenario file and for controlling the recording of the images in the image file.

11. The image recording and editing apparatus of claim 10, further including:
a lens for forming the image in the camera; and
an imaging element for converting the image into digital form.

12. The image recording and editing apparatus of claim 10, further including:
a common data bus;
a microprocessor connected to the common data bus;
an image memory connected to the common data bus;
a compression/decompression circuit connected to the common data bus;
a display driver connected to the common data bus; and
a disk drive connected to the common data bus.

13. The image recording and editing apparatus of claim 10, wherein the recorder includes a disk drive.

14. The image recording and editing apparatus of claim 13, wherein the disk drive is an optical disk drive, and the recording medium is an optical recording medium.

15. The image recording and editing apparatus of claim 10, wherein the controller is a microprocessor-based controller.

16. The image recording and editing apparatus of claim 10, further including a control panel interfacing with the controller.

17. The image recording and editing apparatus of claim 10, further including an image compression/decompression circuit for compressing/decompressing the images.

18. The image recording and editing apparatus of claim 10, further including a display driver to drive the display.

19. The image recording and editing apparatus of claim 10, wherein the scenario file is formed by recording at least one of a replay order or a replay condition of the image file.

20. The image recording and editing apparatus of claim 10, wherein the scenario file comprises at least one of a replaying speed of the image file, a number of repetitions for replaying the image file, a replay range of the image file, a special effect, and a replay of sound associated with the image file.

21. The image recording and editing apparatus of claim 10, wherein the scenario file further optionally includes identification data indicating if other scenario files are recorded as part of the scenario file; and
wherein the recording an editing apparatus further optionally includes a scenario evaluating circuit for evaluating the replay order of the image files by following the corresponding scenario file in a hierarchical manner based on the identification data.

22. The image recording and editing apparatus of claim 10, further including:
a manual replay circuit for replaying the image files recorded in the recording medium according to an external replay operation; and
a first scenario making editor that automatically records a sequence of manual steps as a replay order or replay condition in the scenario file.

23. The image recording and editing apparatus of claim 10, further including:
an edit input unit for receiving the editing operation for the plurality of image files, and a second scenario making editor that records a replay order or a replay condition as a scenario file based on the editing operation input via the edit input unit.

24. The image recording and editing apparatus of claim 10, wherein the controller resolves inconsistencies in the scenario file according to one of a predetermined priority order or an externally supplied instruction.

25. The image recording and editing apparatus of claim 10, wherein thumbnail images are displayed on the display to represent image files and scenario files.

26. The image recording and editing apparatus of claim 10, further including external controls for controlling display of images on the display, and wherein the controller further edits the image files in response to the external controls.

27. An image recording and editing apparatus, comprising:
a camera;
an image memory for storing images received by the camera and connected to a common data bus;
a recording medium;
a disk drive positioned to record data on the recording medium and connected to the common data bus;
a display for displaying images received by the camera;
a display driver for driving the display and connected to the common data bus;
a microprocessor connected to the common data bus for controlling the display in response to a scenario file, wherein the images are recorded on the recording medium as image files by the recorder in response to commands from the controller and instructions stored in a scenario file; and
a compression/decompression circuit connected to the common data bus.

28. The image recording and editing apparatus of claim 27, further including:
a plurality of image files;
a plurality of scenario files, wherein each image has a corresponding scenario file, and wherein the plurality of scenario files and the plurality of image files are arranged hierarchically.

29. A method of capturing and editing images, comprising the steps of:
capturing a first image;
storing the first image on a recording medium;
creating a control instruction;
storing the control instruction as a scenario file; and
displaying the first image, wherein the first image is modified according to the scenario file.

30. The method of claim 29, further including the steps of:
capturing a plurality of images;
storing the plurality of images on the recording medium; and
creating a plurality of control instructions, wherein each of the plurality of image files has a corresponding control instruction.

31. The method of claim 30, further including the step of creating a plurality of scenario files, wherein each of the plurality of scenario files corresponds to at least one of the plurality of image files.

32. The method of claim 31, wherein the plurality of scenario files are constructed in a hierarchical manner.

33. The method of claim 29, wherein the step of creating the control instruction includes the step of creating a scenario file and storing the scenario file on the recording medium.

34. The method of claim 33, wherein the step of creating the scenario file includes a step of storing a plurality of instructions in the scenario file.

35. The method of claim 34, wherein the step of displaying the first image includes a step of resolving possible inconsistencies between each one of the plurality of instructions in the scenario file.

36. The method of claim 33, wherein the step of creating a scenario file includes the step of storing the scenario file on the recording medium.

37. The method of claim 29, wherein the step of capturing the first image captures the first image with a camera.

38. The method of claim 29, wherein the step of storing the first image on a recording medium stores the image on a magneto-optical recording medium.

39. The method of claim 29, wherein the step of storing the first image on a recording medium stores the image on a disk-shaped recording medium using a disk drive.

40. The method of claim 29, wherein the step of capturing the first image includes a step of compressing a digital representation of the first image.

41. The method of claim 29, wherein the step of creating the control instruction creates the control instruction in response to an external input.

42. The method of claim 29, wherein the step of creating the control instruction includes recalling an instruction from memory by a microprocessor.

43. The method of claim 29, wherein the step of displaying the first image includes the step of decompressing a digital representation of the image stored as an image file on the recording medium.

44. The method of claim 29, wherein the control instruction includes at least one of a replay, a delay, a special effect, or a replay order.

45. An image reproducing apparatus, comprising:
a memory for storing an image file including moving image data and a scenario file, wherein the scenario file includes a reproduction start point and a reproduction end point of the moving image data of the image file; and
a reproducer for reproducing the moving image data in accordance with the reproduction start point and the reproduction end point.

46. The image reproducing apparatus according to claim 45, wherein the scenario file includes frame number information corresponding to frame numbers of the moving image data.

47. The image reproducing apparatus according to claim 45, wherein the image file includes time stamp data, and the scenario file includes time information corresponding to the time stamp data.

48. An image reproducing apparatus, comprising:
an image file including moving image data, a reproduction start point of the moving image data, and a reproduction end point of the moving image data;
a memory for storing the image file; and
a reproducer for reproducing the moving image data in accordance with the reproduction start point and the reproduction end point.

49. The image reproducing apparatus of claim 48, further including a scenario file stored in the memory, wherein the scenario file includes at least one of a replaying speed of the image file, a number of repetitions for replaying the image file, a replay range of the image file, a special effect, and a replay of sound associated with the image file.

50. An image reproducing apparatus, comprising:
a memory for storing moving image data, a reproduction start point of the moving image data, and a reproduction end point of the moving image data; and
a reproducer for reproducing the moving image data in accordance with the reproduction start point and the reproduction end point.

51. The image reproducing apparatus of claim 50, wherein the moving image data is stored in an image file, and the reproduction start point of the moving image data and the reproduction end point of the moving image data are stored in a scenario file.

52. The image reproducing apparatus of claim 50, wherein the moving image data, the reproduction start point of the moving image data and the reproduction end point of the moving image data are stored in an image file, wherein the image file is stored in the memory.

53. The image reproduction apparatus of claim 52, further including a scenario file stored in the memory, wherein the scenario file includes at least one of a replaying speed of the image file, a number of repetitions for replaying the image file, a replay range of the image file, a special effect, and a replay of sound associated with the image file.
